(19) United States
(12) Patent Application Publication
(10) Pub. No.: US 2022/0078511 A1
(43) Pub. Date: Mar. 10, 2022

(54) MEDIA PROVIDING SERVER, MEDIA PROVIDING METHOD, AND COMPUTER PROGRAM FOR PROVIDING POP-UP SCREEN TOGETHER WITH BROADCAST INTERFACE

(71) Applicant: SK STOA CO., LTD., Seoul (KR)

(72) Inventor: Young Hoon KOO, Seoul (KR)

(73) Assignee: SK STOA CO., LTD., Seoul (KR)

(21) Appl. No.: 17/462,711

(22) Filed: Aug. 31, 2021

(30) Foreign Application Priority Data
Sep. 4, 2020 (KR) 10-2020-0113201

(51) Int. Cl. H04N 21/431; H04N 21/488; H04N 21/422; H04N 21/478; H04N 21/658

(52) U.S. Cl. CPC H04N 21/4316; H04N 21/4882; H04N 21/6581; H04N 21/47815; H04N 21/42203

(57) ABSTRACT

A method of providing a pop-up screen with a broadcast interface includes receiving, by a media providing server, an access signal from a set-top box, transmitting video identification information of broadcast video data to the set-top box in response to the access signal, determining, by the media providing server, whether a pop-up posting condition is satisfied with respect to the set-top box, generating, by the media providing server, pop-up output data matching the pop-up posting condition when it is determined that the pop-up posting condition is satisfied, and transmitting, by the media providing server, the pop-up output data to the set-top box.

### CROSS-REFERENCE TO RELATED APPLICATION

This application is based on and claims priority under 35 U.S.C. § 119 to Korean Patent Application No. 10-2020-0113201, filed on Sep. 4, 2020, in the Korean Intellectual Property Office, the disclosure of which is incorporated by reference herein in its entirety.

### BACKGROUND

### 1. Field

One or more embodiments relate to a media providing server, a media providing method, and a computer program that provide a pop-up screen together with a broadcast interface.

### 2. Description of the Related Art

With the recent development of TV technology and digital technology, various information is being delivered to viewers through TV. For example, TV home shopping, which provides shopping information through TV, provides various information according to technological change. Meanwhile, with the recent commercialization of digital-based digital television technology, various contents are available through networks such as Internet connected to each home, and an Internet Protocol Television (IPTV) service is a representative example.

In the IPTV service, various services may be provided to IPTV service subscribers through a set-top box installed in a designated space such as a home, and among them, a shopping broadcasting service (or commercial broadcasting) provided through a commerce channel is one of such services.

A commerce business operator producing a shopping broadcasting service may schedule a commerce channel (i.e., a shopping broadcasting service) in an assigned, granted and/or promised channel by paying a certain amount.

Accordingly, when an IPTV service subscriber selects a promised channel on the set-top box, the set-top box receives a commerce channel regularly scheduled for that channel and outputs the commerce channel through the TV, so that the IPTV service subscriber may watch the commerce channel and use the shopping broadcasting service. However, delivery of various shopping information according to a user's request and convenience such as checking shopping information and ordering may be improved.

### SUMMARY

One or more embodiments include a pop-up screen together with a broadcast interface.

Additional aspects will be set forth in part in the description which follows and, in part, will be apparent from the description, or may be learned by practice of the presented embodiments of the disclosure.

According to one or more embodiments, a method of providing a pop-up screen with a broadcast interface, the method includes: receiving, by a media providing server, an access signal from a set-top box, and transmitting video identification information of broadcast video data to the set-top box in response to the access signal; determining, by the media providing server, whether a pop-up posting condition is satisfied with respect to the set-top box; generating, by the media providing server, pop-up output data matching the pop-up posting condition when it is determined that the pop-up posting condition is satisfied; and transmitting, by the media providing server, the pop-up output data to the set-top box.

Whether the pop-up posting condition is satisfied may be determined by whether a broadcast video output from the set-top box is a broadcast video determined in the pop-up posting condition.

In at least one variant, whether the pop-up posting condition is satisfied may be determined by whether a time value of the set-top box is included in the period and time determined in the pop-up posting condition. The pop-up posting condition further includes a current time value of the set-top box that is in a predetermined period.

In another variant, whether the pop-up posting condition is satisfied may be determined by whether at least one of a broadcast video output from the set-top box, a time value, platform information of the set-top box, a voice recognition function of the set-top box, and a characteristic of a product sold in the broadcast video matches that determined in the pop-up posting condition.

In further another variant, the method according to embodiments may further include: receiving, by the media providing server, a selection request signal for a banner included in the pop-up output data from the set-top box; requesting, by the media providing server, video identification information of a store video corresponding to the banner from a data server in response to the selection request signal; receiving, by the media providing server, the video identification information from the data server and transmitting the video identification information to the set-top box.

In another variant, the method according to embodiments may further include receiving, by the media providing server, an extension signal for the pop-up output data from the set-top box and transmitting, by the media providing server, extended pop-up output data corresponding to the banner to the set-top box in response to the extension signal.

In another variant, the method according to embodiments may further include receiving, by the media providing server, a selection request signal for an order function included in the pop-up output data from the set-top box and transmitting, by the media providing server, order output data corresponding to the order function to the set-top box in response to the selection request signal for the order function.

In another variant, the method according to embodiments may further include transmitting, by the media providing server, a signal to remove the pop-up data to the set-top box as a preset pop-up time expires.

In another variant, the pop-up output data may include pieces of banner data and video identification information of a store video corresponding to the banner data, and may be implemented to alternately output the banner data.

According to one or more embodiments, a media providing server includes a communication unit and a processor configured to communicate with a set-top box, wherein the processor receives an access signal from the set-top box, transmits video identification information of broadcast video data to the set-top box in response to the access signal, determines whether a pop-up posting condition is satisfied with respect to the set-top box, generates pop-up output data matching the pop-up posting condition when it is determined that the pop-up posting condition is satisfied, and transmit the pop-up output data to the set-top box.

According to one or more embodiments, a computer program is stored in a medium to execute any one of methods according to an embodiment using a computer.

The pop-up posting condition further comprises a determination of whether at least one of a broadcast video output from the set-top box, a time value, platform information of the set-top box, a voice recognition function of the set-top box, or a characteristic of a product sold in the broadcast video, matches predetermined pop-up posting conditions.

In another variant, the processor is further configured to receive a selection request signal for a banner included in the pop-up output data from the set-top box, request video identification information of a store video corresponding to the banner from a data server in response to the selection request signal, receive the video identification information from the data server, and transmit the video identification information to the set-top box.

A system for providing media includes an input unit that receives a user input, an output unit that displays a user interface for the user input, a communication unit configured to transmit and receive data over a network, a processor unit, and a storage medium. The storage medium is coupled to the processor unit and includes (i) a broadcast video processing unit, upon execution by the processor, configured to receive information about a broadcast video corresponding to a broadcast schedule or a user input, (ii) a pop-up screen processing unit, upon execution by the processor, configured to request and receive pop-up data related to a connected set-top box and generate pop-up output data based on the received pop-up data, (iii) a user input management unit, upon execution by the processor, configured to receive a signal corresponding to a user input obtained from a set-top box, and (iv) a broadcast output management unit, upon execution by the processor, configured to generate output data by combining video identification information with the pop-up output data of the broadcast video. Upon execution by the processor, the pop-up screen processing unit is further configured to determine whether pop-up posting conditions are satisfied, and upon determination that the pop-up posting conditions are satisfied, control a pop-up screen corresponding to the pop-up posting conditions to be output.

In at least one variant, the pop-up screen processing unit is further configured to: upon determination that pop-up posting conditions are satisfied, generate the pop-up output data using a voice recognition function.

In another variant, the pop-up screen processing unit is further configured to: upon determination that pop-up posting conditions are satisfied: generating the pop-up output data including a first type execution user interface corresponding to a first product type included in the broadcast video, and generating the pop-up output data including a second type execution user interface corresponding to a second product type included in the broadcast video.

In further another variant, the pop-up screen processing unit is further configured to: receive a first selection request signal for a banner included in the pop-up output data from the connected set-top box, and transmit video identification information of a store video corresponding to the banner to the connected set-top box in response to the first selection request signal.

In another variant, the pop-up screen processing unit is further configured to: receive a second selection request signal for an order function included in the pop-up data from the connected set-top box, and transmit order output data corresponding to the order function to the connected set-top box in response to the second selection request signal for the order function.

In addition to this, another method and another system for implementing the disclosure, and a non-transitory computer-readable recording medium for recording a computer program for executing the method are further provided.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a network environment of a media providing system that transmits a broadcast video through a media providing server according to embodiments;

FIG. 2 is a block diagram of a media providing server according to embodiments;

FIG. 3 is a view for explaining data transmission/reception between the media providing server and a data server;

FIG. 4 is a flowchart of a pop-up setting method of the media providing server according to an embodiment;

FIG. 5 is an exemplary view of a pop-up setting menu;

FIG. 6 is a flowchart of a method of providing a pop-up screen together with a broadcast video according to an embodiment;

FIG. 7 is an exemplary view of pop-up output data provided according to one embodiment;

FIG. 8 is another exemplary view of pop-up output data provided according to another embodiment;

FIG. 9A is a display example screen before the pup-up data of third output format is extended; and

FIG. 9B is a display example screen in which pop-up data of third output format is extended.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Reference will now be made in detail to embodiments, examples of which are illustrated in the accompanying drawings.

Since the disclosure may have diverse modified embodiments, certain embodiments are illustrated in the drawings and are described in the detailed description. Advantages and features of the present invention, and implementation methods thereof will be clarified through following embodiments described with reference to the accompanying drawings. The disclosure may, however, be embodied in many different forms and should not be construed as limited to the embodiments set forth herein.

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various elements, these elements should not be limited by these terms.

An expression used in the singular encompasses the expression of the plural, unless it has a clearly different meaning in the context.

It will be further understood that the terms “comprises” and/or “comprising” used herein specify the presence of stated features or elements, but do not preclude the presence or addition of one or more other features or elements.

Sizes of elements in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

A set-top box is a hardware device necessary for viewing satellite broadcasting or cable broadcasting at home. Data such as satellite broadcasting, cable broadcasting, or Internet broadcasting is transmitted to the set-top box as data processed through compression and modulation, etc. The set-top box performs a process of demodulation and decompression on received data so that the data may be implemented in a terminal such as a TV.

In this disclosure, the set-top box receives broadcast video data from a content transmission server through a video transmission path, requests selected broadcast video data and/or a user interface to a media providing server, and reproduces the broadcast video data and/or the user interface received from the media providing server. Here, the broadcast video may refer to a video that is transmitted to a plurality of set-top boxes and displayed on output devices connected to a plurality of set-top boxes, respectively. The broadcast video may be simultaneously displayed on output devices connected to a plurality of set-top boxes. Also, the broadcast video may be transmitted to set-top boxes to which a play-input is input, and displayed on an output device connected to the set-top box. Broadcast video is not limited to broadcast video, and refers to image, video, or content.

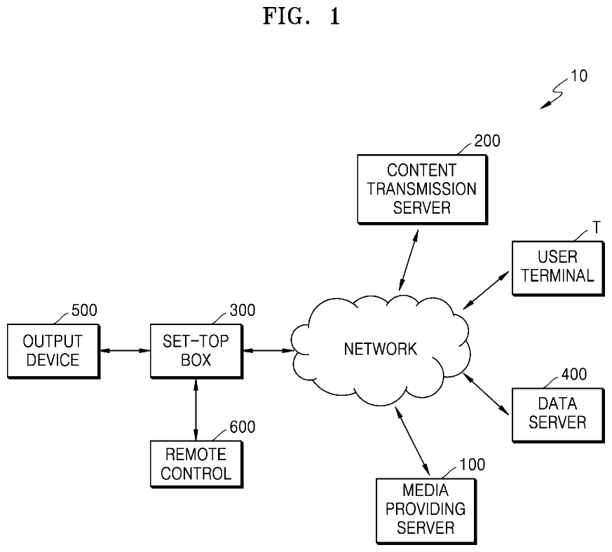

FIG. 1 illustrates a network environment of a media providing system that transmits a broadcast video through a media providing server 10 according to embodiments.

In the media providing system 10, a media providing server 100, a content transmission server 200, a set-top box 300, and a data server 400 may communicate with each other through a network. The data server 400 or the media providing server 100 and a user terminal T may also communicate with each other through the network. Although the communication method of the network of the disclosure is not limited, the network according to some embodiments may use short-range wireless communication. In the media providing system 10, the set-top box 300 may be connected to an output device 500 such as a TV through a network or an electric line. In addition, the set-top box 300 and the output device 500 such as a TV may be implemented as one piece of hardware. The media providing system 10 may further include a remote control device (e.g., a remote control 600) for communicating with the set-top box 300 and/or the output device 500 such as a TV. The set-top box 300 or the output device 500 such as a TV may communicate with the remote control 600 through a local area network.

The set-top box 300 may be installed in a designated space, such as a home, to provide a broadcast service. The set-top box 300 may provide a broadcasting service such as a shopping broadcasting service through a commerce channel.

The set-top box 300 may communicate with the media providing server 100 and the content transmission server 200 through the network. The set-top box 300 may transmit data received from the media providing server 100 and the content transmission server 200 to the output device 500 such as a TV. The output device 500 includes a TV, a smart TV, and the like, and may include any type of electronic device having a display, such as a smart phone or a portable media player.

The set-top box 300 may transmit a user input from a separate input device or the output device 500 such as a TV to the media providing server 100.

The media providing system 10 may generate output data for broadcasting through the media providing server 100, and may transmit the output data for broadcasting from the media providing server 100 to the set-top box 300.

The media providing server 100 may generate output data for broadcasting based on data received from the data server 400. The media providing server 100 may generate output data for outputting a broadcast video and a preset pop-up screen corresponding to a broadcast schedule. The media providing server 100 may obtain information about a broadcast video to be output from the data server 400 and generate output data for broadcasting including video identification information about the obtained broadcast video. The media providing server 100 may generate output data including video identification information for a broadcast video and a user interface. The media providing server 100 may perform a function of generating a user interface using data stored in the data server 400. The media providing server 100 may receive data necessary for generating output data for broadcasting from the data server 400. The media providing server 100 may receive product information, customer information, order information, schedule information, and the like from the data server 400.

The media providing server 100 may generate output data including a pop-up screen together with a broadcast video. The pop-up screen is output when a pop-up posting condition is satisfied, and may be a screen output in addition to a broadcast video. The pop-up screen may include a banner set by an administrator, a function area, an information area, a movement area to another page, and the like. The pop-up screen may overlap a broadcast video or may be output adjacent to the broadcast video. The pop-up screen may be output in an output format set by an administrator, and may be output by setting one of preset output formats. The pop-up screen may be output in one of, for example, a first output format output on a broadcast video, a second output format output at the bottom of the broadcast video, and a third output format output on the left and right sides of the broadcast video, but it is not limited thereto and may have various output formats. For example, an output position of the pop-up screen may be one of the top, left, right, and bottom of the broadcast video, and may be output to the entire area of the output screen. The pop-up screen may be additionally output to a broadcast video and a store video, but it is not limited thereto and may be additionally output to various interfaces.

One pop-up screen may include one or more banners or one or more icons. In this case, one or more banners may be output simultaneously or alternately. The pop-up screen may include various dynamic effects, such as being output in a first form, which is a minimized form, and output in a second form, which is an extended form, in response to a user input. An output form of the pop-up screen may be changed as set by the user terminal T.

The media providing server 100 may request data on the pop-up screen from the data server 400 and output the pop-up screen based on the data on the pop-up screen.

In addition, the media providing server 100 may control the set-top box 300 through a program installed in the set-top box 300. The media providing server 100 may perform a function of reading information of the set-top box 300. The media providing server 100 may receive platform code, an STP ID, and access information of the set-top box 300. The media providing server 100 may generate output data of the set-top box 300 based on the information of the set-top box 300. The media providing server 100 may regenerate output data for broadcasting in response to a user input obtained through the set-top box 300 and transmit the output data for broadcasting to the set-top box 300.

The media providing server 100 may display, instead of information containing various contents such as actions, capture information of these contents on a screen of the output device 500 such as a TV through the set-top box 300 through a cloud solution.

The media providing server 100 may control conversion of a first cloud server and a second cloud server having different types when implementing an application using a cloud server.

The media providing server 100 may implement a screen in the output device 500 such as a TV by driving an application corresponding to a selected channel through the first cloud server, and may accommodate a plurality of users through this. Thereafter, when a user moves a focus or manipulates a remote control only once, the user may change the connection to the first cloud server.

The set-top box 300 may communicate with the media providing server 100 to receive output data, interpret and read (encode, etc.) the received output data, and output the output data through the output device 500 such as a TV. The set-top box 300 may obtain a user input through a provided input device and transmit a request signal corresponding to the user input to the media providing server 100. The set-top box 300 may communicate with the media providing server 100 and control the output of a broadcast video.

The content transmission server 200 may transmit content such as a broadcast video of one or more broadcast channels through the set-top box 300. In this case, the content transmission server 200 may transmit content to servers of various broadcast providers. The content transmission server 200 may store content such as a broadcast video suitable for a platform or format of a broadcast provider. The content transmission server 200 may transmit the stored content to the set-top box 300 described above so that content such as a broadcast video is reproduced on the output device 500. The content transmission server 200 may receive data of content, such as a broadcast video, from a content providing server (not shown) through other transmission paths such as a network (e.g., a distributed network or a contents delivery network (CDN)).

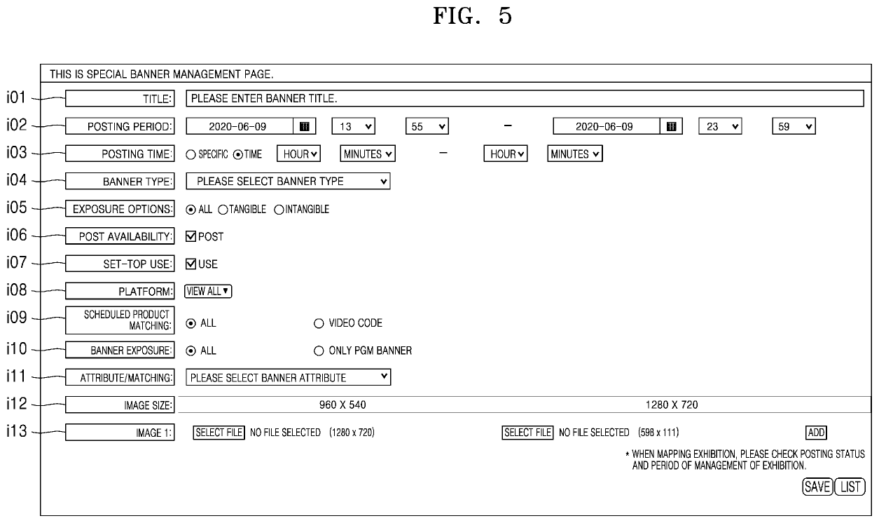

The data server 400 may store and manage information for generating data for broadcast output. The data server 400 may store and manage information related to pop-up settings. The information related to the pop-up setting may be obtained through a pop-up setting menu screen shown in FIG. 5. The information related to the pop-up setting may include a title, a posting period, a posting time, a banner type, an exposure option, post availability, whether a specific set-top is used, a platform, scheduled product matching information, banner exposure information, attribute/matching information, image size information, image file upload information, and the like.

The data server 400 is a computing device in which server programs such as Apache Tomcat@ and Oracle are installed and may be implemented to process server functions. The data server 400 may store product information, production information, and/or deliberation information of content as described above. In addition, the data server 400 may store video identification information, pop-up data, and the like, and provide related information to the media providing server 100 in response to a request from the media providing server 100.

The media providing system 10 according to an embodiment may further include a content providing server (not shown). The content providing server may register (e.g., get and store) content such as a commercial video to be provided. In addition, the content providing server may receive meta information of content such as a video from the data server 400 and match meta information for each content. To this end, the content providing server may be connected to the data server 400 and may exchange various information therewith through communication.

The content providing server may convert content such as a registered video according to the platform or format of each broadcaster and transmit the converted content to the content transmission server 200. However, the disclosure is not limited thereto, and the content providing server may store content and transmit the content to the content transmission server 200, and the content transmission server 200 may convert and store the content according to a platform or format of a broadcaster. This also applies to the following embodiments and variations thereof.

The content providing server may obtain meta information of content from the data server 400. The meta information may include product information, production information, and/or deliberation information related to the corresponding content. However, in some cases, the content providing server may directly receive and store meta information from a content provider.

The content providing server may transmit data of content such as a video or data of converted content to the content transmission server 200 through a CDN. In addition, the content providing server may receive video identification information of each video from the content transmission server 200. The video identification information may be, for example, reproduced URL information stored in the content transmission server 200.

The user terminal T may be, for example, at least one of a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, and a wearable device. The user terminal T may communicate with the data server 400 or the media providing server 100 over the network.

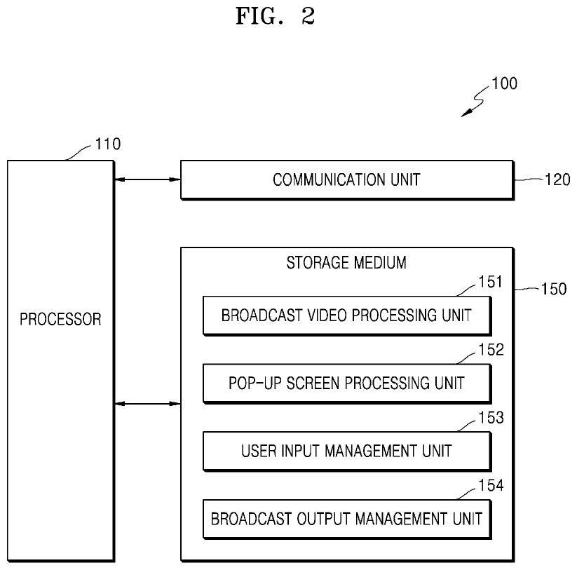

FIG. 2 is a block diagram of the media providing server 100 according to embodiments.

A processor 110 is a configuration for controlling the media providing server 100. In more detail, the processor 110 controls all operations of the media providing server 100 by using various programs stored in a storage medium 150 of the media providing server 100. For example, the processor 110 may include a central processing unit (CPU), RAM, ROM, and a system bus. The ROM is a configuration in which an instruction set for system boot is stored, and the CPU copies an operating system stored in the media providing server 100 into the RAM according to an instruction stored in the ROM and executes an O/S to boot a system. When booting is complete, the CPU may perform various operations by copying various stored applications to the RAM and executing them. Although it has been described above that the media providing server 100 includes only one CPU, the media providing server 100 may be implemented with a plurality of CPUs (or a digital signal processor (DSP), a system on chip (SoC), etc.).

According to an embodiment, the processor 110 may be implemented as a DSP processing a digital signal, a microprocessor, or a time controller (TCON). However, the processor 110 is not limited thereto, and may include one or more of a CPU, a micro controller unit (MCU), a micro processing unit (MPU), a controller, an application processor (AP), a communication processor (CP), and an advanced RISC machine (ARM) processor, or may be defined in a corresponding term. In addition, the processor 110 may be implemented as an SoC or a large-scale integration (LSI) in which a processing algorithm is embedded, or may be implemented in the form of a field programmable gate array (FPGA).

The media providing server 100 may include one more input device or one more output device.

A communication unit 120 is configured to transmit and receive data to and from devices such as the content transmission server 200, the data server 400, and the set-top box 300. The communication unit 120 may include a short-range communication unit such as a Bluetooth® communication unit, a Bluetooth® low energy (BLE) communication unit, a near-field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit, a mobile communication network, or a wired Ethernet network.

The media providing server 100 may further include the storage medium 150 storing various data for overall operations, such as a program for processing or controlling the processor 110. In more detail, the storage medium 150 may store a plurality of application programs (or applications) driven in the media providing server 100, and data and instructions for the operation of the media providing server 100. At least some of these application programs may be downloaded from an external server through wireless communication. In addition, at least some of these application programs may be on the media providing server 100 from the time of shipment for a basic function of the media providing server 100. The application program may be stored in a storage medium and driven to perform the operation (or function) of the media providing server 100 by the processor 110.

The storage medium 150 may include a broadcast video processing unit 151, a pop-up screen processing unit 152, a user input management unit 153, and a broadcast output management unit 154 to output a broadcast video and a pop-up screen.

The broadcast video processing unit 151 may receive information about a broadcast video corresponding to a broadcast schedule or a user input from the data server 400, and may transmit the information about the broadcast video, for example, video identification information to the set-top box 300.

The pop-up screen processing unit 152 may request and receive pop-up data related to a connected set-top box from the data server 400 and may generate pop-up output data based on the received pop-up data. The pop-up data may include an output format of a pop-up screen, information about an included banner, pop-up posting conditions, and the like. The output format of the pop-up screen may be one of a first output format output on a broadcast video, a second output format output at the bottom of the broadcast video, and a third output format output on the left and right sides of the broadcast video. The information about the included banner is about the banner included in the pop-up screen, and may include the name of a banner image, identification information, link information, and the like. The pop-up data may include a pop-up posting condition and information about one or more pop-up screens.

The pop-up screen processing unit 152 determines whether the set-top box 300 satisfies the pop-up posting condition and controls a pop-up screen corresponding to the pop-up posting conditions to be output. Pop-up screens may be respectively output in response to a plurality of pop-up posting conditions. For example, a first pop-up screen may be output under a first pop-up posting condition, and a second pop-up screen may be output under a second pop-up posting condition.

In more detail, the pop-up screen processing unit 152 may determine whether a pop-up posting condition is satisfied based on whether a broadcast video output from a set-top box is a broadcast video determined in the pop-up posting condition, and may transmit pop-up output data to the set-top box 300 when the pop-up posting condition is satisfied.

The pop-up screen processing unit 152 may determine whether a pop-up posting condition is satisfied by whether a time value of a set-top box is in a period and time determined in the pop-up posting condition, and may transmit pop-up output data to the set-top box 300 when the pop-up posting condition is satisfied. The pop-up output data may be implemented to be output in a certain time range at a certain time interval.

The pop-up screen processing unit 152 may determine whether a pop-up posting condition is satisfied by at least one of a broadcast video output from a set-top box, a time value, platform information of the set-top box, a voice recognition function of the set-top box, and a characteristic of a product sold in the broadcast video. The pop-up screen processing unit 152 receives the platform information of the set-top box from the set-top box 300 and determines that the pop-up posting condition is satisfied when the platform information belongs to predetermined company. The pop-up screen processing unit 152 may determine whether the pop-up posting condition is satisfied based on whether the set-top box has a voice recognition function. In addition, when the set-top box is capable of voice recognition, pop-up output data may be generated to include a phrase such as ‘Please speak to me’ in connection with a voice function.

The pop-up screen processing unit 152 may determine whether the pop-up posting condition is satisfied by considering whether the nature of the product sold in the broadcast video is a tangible or intangible product. Products such as food, clothes, and furniture may be classified as tangible products, and services such as insurance, travel products, and rental services may be classified as intangible products. The pop-up screen processing unit 152 may generate pop-up output data including an ‘order’ function in the case of a tangible product, and may generate pop-up output data including a ‘helpline’ function in the case of an intangible product.

The pop-up screen processing unit 152 receives a selection request signal for a banner included in pop-up output data from the set-top box 300 and may transmit video identification information of a store video corresponding to the banner to the set-top box 300 in response to the selection request signal. The video identification information of the store video corresponding to the banner may be included in pop-up data received from the data server 400 and transmitted to the set-top box 300.

The pop-up screen processing unit 152 may receive an extension signal included in pop-up output data from the set-top box 300 and transmit extended pop-up output data corresponding to a banner to the set-top box 300 in response to the extension signal. Data for an extended pop-up may be included in the pop-up data received from the data server 400. The pop-up screen displayed by the extended pop-up output data may refer to a pop-up screen that is extended from a pop-up screen of a first size to a pop-up screen of a second size.

The pop-up screen processing unit 152 may receive a selection request signal for an order function included in pop-up output data from the set-top box 300. The pop-up screen processing unit 152 may transmit order output data corresponding to the order function to the set-top box 300 in response to the selection request signal for the order function. The order output data refers to output data for the order function. The output data for the order function may include a thumbnail of a product, video information of the product, an icon for moving to an order page, and the like. The pop-up output data may be implemented to be removed as a preset pop-up time expires.

In an alternative embodiment, the pop-up screen processing unit 152, considering an output state of a broadcast video in the set-top box 300, determines whether a pop-up posting condition of the broadcast video is satisfied. The pop-up screen processing unit 152, considering whether a broadcast video is reproduced or stopped, may determine whether a pop-up posting condition of the broadcast video is satisfied. In addition, the pop-up posting condition, considering an output state of a broadcast video, may be set such as whether a reproduction time of the broadcast video is a preset specific time, whether a reproduction start time of the broadcast video in the set-top box 300 is out of a preset specific time range, or whether a user input such as an order or selection for the broadcast video occurs. However, the pop-up posting condition is not limited thereto, and may consider the output state of the broadcast video.

In an alternative embodiment, pop-up output data may be output considering an output state of the set-top box 300 at the time of posting a pop-up. For example, when a broadcast video is output in the output state of the set-top box 300, an output location, an output format, etc. of a pop-up screen may be determined considering information included in the broadcast video. When a search interface is output in the output state of the set-top box 300, an output location, an output format, etc. of a pop-up screen may be determined considering an input area and a search result provision area in the search interface.

The pop-up screen processing unit 152 may request the set-top box 300 for an output state of a broadcast video to receive information such as a current reproduction time, a reproduction start time, and a user input from the set-top box 300 and may determine whether a pop-up posting condition is satisfied based on the received information.

When it is determined that the pop-up posting condition is satisfied, the pop-up screen processing unit 152 may transmit pop-up output data matching the pop-up posting condition to the set-top box 300. Pop-up output data corresponding to the pop-up posting condition may be generated. For example, when a first pop-up posting condition is matched, pop-up output data in which a pop-up of a first output format is output may be generated, and when a second pop-up posting condition is matched, pop-up output data in which a pop-up in a second output format is output may be generated.

The pop-up screen processing unit 152, from among one or more set-top boxes to which a first broadcast video is output, may transmit pop-up output data to a first set-top box that satisfies the pop-up posting condition, and the pop-up screen processing unit 152 may not transmit pop-up output data to a second set-top box that does not satisfy the pop-up posting condition.

The pop-up screen may be implemented including a banner. In this case, a selection input for the pop-up screen may be received. In more detail, the pop-up screen processing unit 152 may receive a selection request signal for a banner included in pop-up output data from the set-top box 300. The pop-up screen processing unit 152 may request the data server 400 for video identification information of a store video corresponding to the banner in response to the selection request signal and may transmit the video identification information received from the data server 400 to the set-top box 300.

The pop-up screen may be implemented in a third output format that is output in a first format and is converted into a second format by a user input. In this case, the pop-up screen processing unit 152 may receive an extension signal (selection signal) for pop-up output data output in the third output format from the set-top box 300 and may transmit extended pop-up output data to the set-top box 300 in response to the extension signal (selection signal). Size-variable pop-up data may be implemented to be displayed together with a dynamic effect.

Another type of a pop-up screen may be implemented including an order function area. In this case, the pop-up screen processing unit 152 may receive a selection request signal for an order function included in pop-up output data from the set-top box 300 and may transmit order output data corresponding to an order function of ordering a product of the broadcast video to the set-top box 300 in response to the selection request signal.

In addition, the pop-up output data may include pieces of banner data and may include pieces of video identification information of store videos corresponding to the pieces of banner data. The pieces of banner data may be implemented to be output crosswise.

The pop-up output data may include a priority value related to an output order. When a pop-up posting condition of pieces of pop-up output data is satisfied, a pop-up screen having the largest priority value may be output.

The user input management unit 153 may receive a signal corresponding to a user input obtained from the set-top box 300. The user input management unit 153 may transmit a signal corresponding to the user input to the pop-up screen processing unit 152 so that corresponding processing may be performed.

The broadcast output management unit 154 may generate output data to be output from an output device by combining video identification information with pop-up output data of a broadcast video. The output data may be output through an output device such as a TV through the set-top box 300.

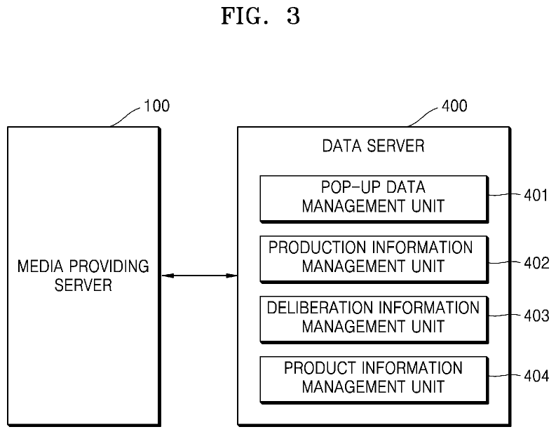

FIG. 3 is a view for explaining data transmission/reception between the media providing server 100 and a data server 400.

The media providing server 100, while outputting a broadcast video, may generate pop-up output data corresponding to the broadcast video. The media providing server 100 may receive pop-up output data based on pop-up data registered in the data server 400.

The data server 400 may include a pop-up data management unit 401, a production information management unit 402, a deliberation information management unit 403, and a product information management unit 404.

The pop-up data management unit 401 may store pop-up data for a broadcast video. The pop-up data management unit 401 may store pop-up data to be output for each broadcast video. The pop-up data may be stored by matching with a pop-up posting condition. The pop-up data may include a title, a posting period, a posting time, a banner type, an exposure option, post availability, whether a specific set-top is used, a platform, scheduled product matching information, banner exposure information, attribute/matching information, image size information, image file upload information, and the like. For example, the pop-up data may be managed by posting time or by broadcast video. The pop-up data may be managed according to a plurality of pop-up posting conditions for one posting time or broadcast video. The pop-up posting conditions of the pop-up data may be set in relation to a broadcast video, a posting time, a platform, whether a specific set-top is used, the nature of a product for sale of the broadcast video, and the like.

The production information management unit 402 may manage production information for a broadcast video. The deliberation information management unit 403 may manage deliberation information for broadcast videos. The product information management unit 404 may manage information on products sold in a broadcast video. Pop-up data and/or pop-up posting conditions may be managed in connection with production information, deliberation information, and product information of a broadcast video.

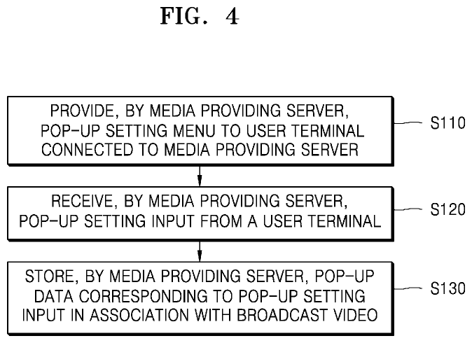

FIG. 4 is a flowchart of a pop-up setting method of the media providing server 100 according to an embodiment.

In operation S110, the media providing server 100 may provide a pop-up setting menu to a user terminal connected thereto. The pop-up setting menu may be provided as shown in FIG. 5. The pop-up setting menu may include a title input area, a posting period input area, a posting time input area, a banner-type input area, an exposure option input area, a post availability input area, a set-top use input area, a platform input area, a scheduled product matching input area, a banner exposure input area, an attribute/matching input area, an image size input area, and image selection input areas. The present disclosure is not limited thereto and may further include various areas.

In operation S120, the media providing server 100 may receive a pop-up setting input from a user terminal.

In operation S130, the media providing server 100 may store pop-up data corresponding to the pop-up setting input in association with a broadcast video. The pop-up setting method of FIG. 4 may be performed by a media management device separate from the media providing server 100.

FIG. 5 is an exemplary view of a pop-up setting menu.

As shown in FIG. 5, the media providing server 100 may provide a pop-up setting menu to a user terminal. The media providing server 100 may provide an administrator mode function related to a pop-up setting function. In addition, the pop-up setting menu may be provided through a media management device (not shown) that provides the administrator mode function of the pop-up setting function. The media management device may be implemented to provide a function related to pop-up setting from among functions of the media providing server 100.

The pop-up setting menu provided through the media providing server 100 or the media management device may include a title input area i01, a posting period input area i02, a posting time input area i03, a banner-type input area i04, an exposure option input area i05, a post availability input area i06, a specific set-top use input area i07, a platform input area i08, a scheduled product matching input area i09, a banner exposure input area i10, an attribute/matching input area i11, an image size input area i12, and an image upload input area i13, for inputting exposure posting conditions for pop-up data.

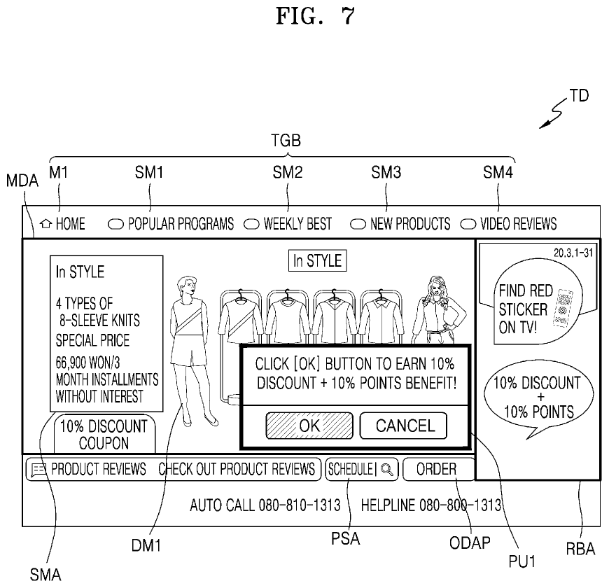

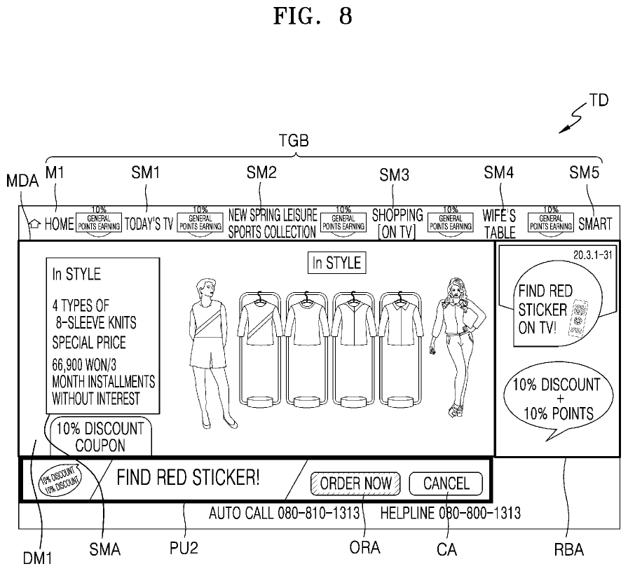

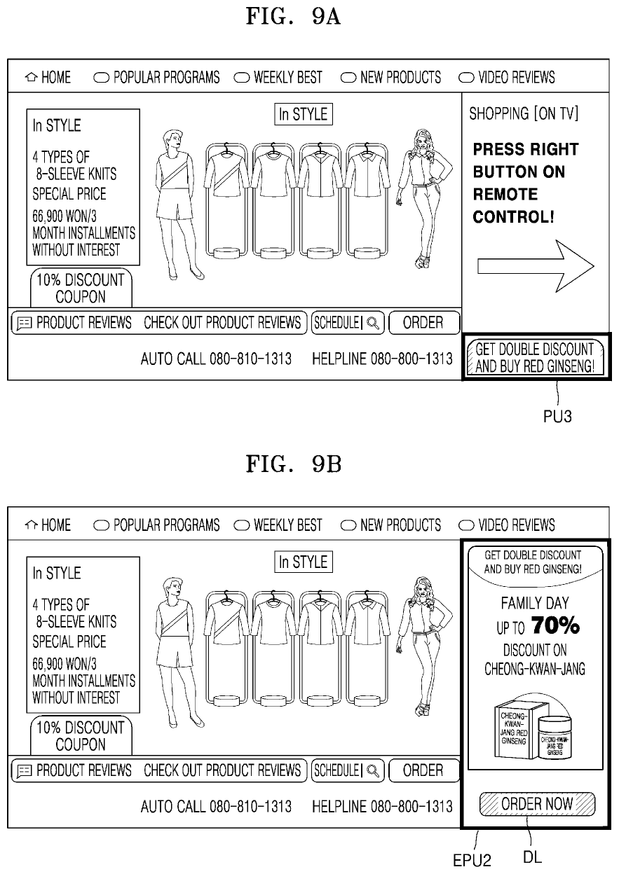

A selection input for an output format of pop-up data may be provided in the banner-type input area i04. For example, the banner-type input area i04 may include “banner in ending pop-up”, “banner at the bottom of VOD video”, and “right BIG banner”. When “banner in ending pop-up” is selected by a user, pop-up data may be set to be output as shown in PU1 of FIG. 7. When “banner at the bottom of VOD video” is selected, pop-up data may be set to be output like PU2 of FIG. 8. When “right BIG banner” is selected, pop-up data may be set to be output like PU3 and EPU2 of FIG. 9A and FIG. 9B. Pop-up data may be implemented including a motion effect. For example, when a selection input is received in an area of pop-up data, the pop-up data may include a certain dynamic effect.

In the exposure option input area i05, the nature of a product for sale may be selected from among exposure posting conditions of pop-up data. The nature of the product for sale to which pop-up data is exposed may be designated as either a tangible product or an intangible product and posted. Alternatively, the nature of the sales product to which the pop-up data may be both tangible and intangible. In the post availability input area i06, whether to post pop-up data may be selected. In order to stop posting of pop-up data, posting of pop-up data may not be checked. In a specific set-top use input area i07, a model of a set-top box to which pop-up data is exposed may be selected. In the platform input area i08, platform information of a set-top box to which pop-up data is exposed may be selected. In the scheduled product matching input area i09, video identification information of a broadcast video to which pop-up data is exposed may be input. In the banner exposure input area i10, information on whether or not to expose a banner may be input together with pop-up data. In the attribute/matching input area i11, a type of banner exposed together with pop-up data may be input. In the image size input area i12, the size of an image provided with pop-up data may be input. In the image upload input area i13, an image file provided with pop-up data may be input.

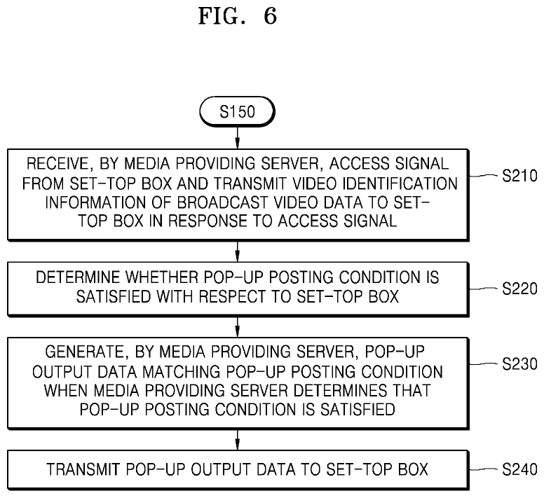

FIG. 6 is a flowchart of a method of providing a pop-up screen together with a broadcast video according to an embodiment.

In operation S210, the media providing server 100 receives an access signal from the set-top box 300 and transmits video identification information of broadcast video data to the set-top box 300 in response to the access signal.

In operation S220, the media providing server 100 determines whether a pop-up posting condition is satisfied with respect to the set-top box 300. Whether or not a pop-up posting condition is satisfied may be determined considering video identification information, a time value of the set-top box 300, or product information for sale of a video.

In operation S230, when the media providing server 100 determines that the pop-up posting condition is satisfied, the media providing server 100 may generate pop-up output data matching the pop-up posting condition. The media providing server 100 may receive pop-up data from the data server 400 and generate pop-up output data based on the pop-up data. However, when other pop-up data is programmed to be output when the pop-up posting condition is satisfied, whether to output the pop-up output data may be determined by considering the priority between the pop-up output data matching the pop-up posting condition and the other pop-up data. When the priority of the pop-up output data is low, the pop-up output data is not displayed and may be displayed after the other pop-up data disappears. Pop-up data may include an output format of a pop-up screen, information about an included banner, pop-up posting conditions, and the like. The output format of the pop-up screen may be one of a first output format output on a broadcast video, a second output format output at the bottom of the broadcast video, and a third output format output on the left and right sides of the broadcast video, but is not limited thereto and may vary. The information about the included banner is about a banner included in the pop-up screen, and may include a banner image, movement information, a functional area, and the like. In operation S240, the media providing server 100 may transmit pop-up output data to the set-top box 300.

The media providing server 100 may provide the pop-up output data PU1, PU2, and PU3 of FIGS. 7 to 9. An output format of pop-up output data is set by an administrator and may be selected as one of the first to third output formats output on a main video.

The pop-up output data PU1 of the first output format may be transmitted and output to the set-top box 300. The pop-up output data PU1 may include a banner for obtaining benefit information such as a discount. When a selection input for a benefit information banner is received, output data providing benefit information on current video content may be generated and transmitted to the set-top box 300.

The pop-up output data PU2 of the second output format may be transmitted and output to the set-top box 300. The pop-up output data PU2 may include an order banner. When a selection input for the order banner is received, output data for directly ordering a product for sale of current video content may be generated and transmitted to the set-top box 300.

The pop-up output data PU3 of the third output format may be transmitted and output to the set-top box 300. The pop-up output data PU3 may include a minimal icon, and when a selection input for the minimal icon is received, extended pop-up output data including advertisement content may be generated and transmitted to the set-top box 300. Extended pop-up output data EPU2 may generate order output data for a product included in advertisement content and transmit the data to the set-top box 300. Advertisement content is different from main video content and may be advertisement content for a product registered by an administrator. When a selection input for order now DL included in the extended pop-up output data EPU2 is received, order output data included in advertisement content may be output from the set-top box 300. A user may perform a procedure for purchasing a product included in pop-up output data.

FIG. 7 is an exemplary views of pop-up output data of first output format provided according to embodiments.

FIG. 7 shows an output screen TD output through an output device.

When a pop-up posting condition is satisfied while broadcast video data DM1 is displayed on the output screen TD, the pop-up output data PU1 of a first output format may be displayed. While the broadcast video data DM1 matched to a time schedule of a channel selected by a user through manipulation of a remote control, etc. is displayed in a main video display area MDA, the pop-up output data PU1 may be displayed in one area of the main video display area MDA. The pop-up output data PU1 may satisfy a pop-up posting condition. As shown in FIG. 7, a banner for obtaining benefit information such as a discount may be displayed through the pop-up output data PU1. When a selection input for the banner is received, a function of obtaining benefit information may be executed. An output position of the pop-up output data PU1 may overlap a broadcast video, but the output position may be various, such as left, right, upper, lower, and the like.

The pop-up output data PU1 may further include an order now banner. When a selection input for the order now banner is received, the media providing server 100 may request a currently broadcast product code and move to an order screen for the product code.

In an alternative embodiment, an additional information area SMA may be displayed on the main video display area MDA to overlap the broadcast video data DM1. The additional information area SMA may include text, image form, or separate video information. The additional information area SMA may include information related to an item (product, etc.) included in the broadcast video data DM1. For example, a product name, price, or event details may be displayed, and the additional information area SMA may be easily displayed by driving one or more applications.

In one area of the output screen TD, for example, at the top of the screen, for example, a navigation bar TGB may be displayed as a selection input area. The navigation bar TGB may be arranged and displayed on the top of the main video display area MDA.

The navigation bar TGB may include a channel main store video selection unit M1 and a plurality of store video selection units SM1, SM2, SM3, and SM4.

When there is no separate selection by a user or immediately after channel selection, the broadcast video data DM1 may be displayed, and a user may select and view other store videos, for example, store video information corresponding to “Popular Program”, store video information corresponding to “Weekly Best”, and store video information corresponding to “New Product”. As a specific example, a user may select and input the navigation bar TGB through an input selection operation such as operation of a remote control direction key to check other store videos.

In response to a video displayed on the output screen TD, the navigation bar TGB may be selected and distinguished. For example, when the broadcast video data DM1 is displayed, the corresponding channel main store video selection unit M1 is displayed differently from the area of the navigation bar TGB and may be highlighted in a different color or underlined.

As an alternative embodiment, a banner area RBA may be displayed on the output screen TD. When the banner area RBA is selected, one or more videos corresponding to the banner area RBA in advance may be displayed, and these videos may include shopping deal information. The selection of the banner area RBA may be made possible by moving a cursor directly with a remote control, or by pressing a direction key button. At this time, by displaying a direction key button DA, a user may select and input the direction key button DA or press a button in the same direction as the direction of the direction key button DA, for example, a right direction key button of the remote control, thereby improving the intuitive convenience of a user. As a specific example, by arranging the banner area RBA in a right area and pressing a right direction key, the convenience of use may be increased.

As an alternative embodiment, the position of the banner area RBA may vary, and depending on the position of the banner area RBA, the type of the selection button may be various direction keys, for example, a left direction key, an up direction key, or a down direction key.

A state information selection area RPA may be displayed in one area of the output screen TD, for example, in a lower portion of the main video display area MDA in which the broadcast video data DM1 is displayed.

As an alternative embodiment, when a user starts an operation, for example, an operation of a direction key on a remote control, or points to or selects the state information selection area RPA as a specific example, the shape or color of the state information selection area RPA changes, so that the user's input convenience may be improved. When a user inputs a selection, a corresponding video, for example, a review page of a plurality of buyers related to an item included in the broadcast video data DM1, may be displayed.

As an alternative embodiment, a schedule information area PSA may be displayed on one area of the output screen TD, and when a user selects, schedule content for each time period, for example, summary information of the broadcast video data DM1 for each time period, may be displayed.

As an alternative embodiment, an order selection area ODAP may be displayed on one area of the screen TD, and a video displayed when a user selects, for example, an order processing process of an item included in the broadcast video data DM1, may be displayed. For example, various order follow-up processes such as ARS drive control or simple ordering may be performed.

FIG. 8 is an exemplary views of pop-up output data of second output format provided according to embodiments.

FIG. 8 shows the output screen TD output through an output device.

When a pop-up posting condition is satisfied while the broadcast video data DM1 is displayed on the output screen TD, the pop-up output data PU2 of the second output format may be displayed. While the broadcast video data DM1 is displayed in the main video display area MDA, the pop-up output data PU2 may be displayed in a lower area of the main video display area MDA. An order banner may be displayed through the pop-up output data PU2. When a selection input for the order banner is received, an order function may be executed.

When the selection input for the order now banner is received, the media providing server 100 may request a currently broadcast product code and move to an order screen for the product code.

FIG. 9A is a display example screen before the pup-up data of third output format is extended, and FIG. 9B is a display example screen in which pop-up data of third output format is extended.

FIG. 9A shows the output screen TD output through an output device.

When a pop-up posting condition is satisfied while the broadcast video data DM1 is displayed on the output screen TD, the pop-up output data PU3 of the third output format may be displayed. While the broadcast video data DM1 is displayed in the main video display area MDA, extended pop-up output data PU3 may be displayed in a right area of the main video display area MDA. The extended pop-up output data PU3 is output to the right side of the main video display area MDA, but it is not limited thereto and may be output to various locations. When a selection input for the extended pop-up output data PU3 is received, the extended pop-up output data EPU2 may be displayed. The extended pop-up output data EPU2 may include various functional areas such as a benefit information output banner, an order banner, and movement to other video data.

The above-described devices may be implemented by hardware components, software components, and/or any combination thereof. For example, the devices and components described in the example embodiments may be implemented by using processors, arithmetic logic units (ALUs), digital signal processors, microcomputers, field programmable gate arrays (FPGAs), programmable logic units (PLUs), microprocessors, one or more general-purpose computers or special-purpose computers, or any other devices that may execute and respond to instructions. The processing device may execute an operating system (OS) and one or more software applications executed in the OS. In addition, the processing device may access, store, operate, process, and generate data in response to the execution of software. For convenience of understanding, it may be described that one processing device is used. However, those or ordinary skill in the art will understand that the processing device may include a plurality of processing elements and/or various types of processing elements. For example, the processing device may include a plurality of processors or a processor and a controller. In addition, the processing device may include any other processing configurations such as parallel processors.

The software may include computer programs, code, instructions, or any combination thereof, and may construct the processing apparatus for desired operations or may independently or collectively command the processing apparatus. In order to be interpreted by the processing apparatus or to provide commands or data to the processing device, the software and/or data may be permanently or temporarily embodied in any types of machines, components, physical devices, virtual equipment, computer storage mediums, or transmitted signal waves. The software may be distributed over network coupled computer systems so that it may be stored and executed in a distributed fashion. The software and data may be stored in one or more computer-readable recording mediums.

The method according to an embodiment may be implemented as program commands which can be executed by various computer devices, and recorded on a computer-readable recording medium. The computer-readable recording medium may include program commands, data files, data structures or a combination thereof. Program instructions recorded on the medium may be particularly designed and structured for example embodiments or available to those skilled in computer software. Examples of the computer-readable recording medium include magnetic media (e.g., hard discs, floppy discs, or magnetic tapes), optical media (e.g., CD-ROMs or DVDs), magneto-optical media (e.g., floptical discs), and hardware devices that are specially configured to store and carry out program commands (e.g., ROMs, RAMs, or flash memories). Program commands may include, for example, high-level language code that can be executed by a computer using an interpreter, as well as machine language code made by a compiler. The above hardware devices may be configured to operate as one or more software modules to perform the operations of the embodiments, and vice versa.

A media providing server, method, and computer program according to embodiments may provide a pop-up screen together with a broadcast interface.

Although the embodiments have been described with reference to the accompanying drawings, one of ordinary skill in the art will understand that various changes and modifications may be made therein. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of providing a pop-up screen with a broadcast interface, the method comprising:
receiving, at a media providing server, an access signal from a set-top box;
transmitting video identification information of broadcast video data to the set-top box in response to the access signal;
determining, with the media providing server, whether a pop-up posting condition is satisfied with respect to the set-top box;
upon determination that the pop-up posting condition is satisfied, generating, with the media providing server, pop-up output data matching the pop-up posting condition; and
transmitting, by the media providing server, the pop-up output data to the set-top box.

2. The method of claim 1, wherein the pop-up posting condition comprises whether a broadcast video displayed by the set-top box is a predetermined video.

3. The method of claim 1, wherein the pop-up posting condition further comprises a current time value of the set-top box that is in a predetermined period.

4. The method of claim 1, wherein determining whether the pop-up posting condition is satisfied further comprises determining whether:
at least one of a broadcast video output from the set-top box;
a time value;
platform information of the set-top box;
a voice recognition function of the set-top box; or
a characteristic of a product sold in the broadcast video;
matches predetermined pop-up posting conditions.

5. The method of claim 1, further comprising:
receiving, at the media providing server, a selection request signal for a banner included in the pop-up output data from the set-top box;
requesting, by the media providing server, video identification information of a store video corresponding to the banner from a data server in response to the selection request signal; and
receiving, at the media providing server, the video identification information from the data server and transmitting the video identification information to the set-top box.

6. The method of claim 1, further comprising:
receiving, at the media providing server, an extension signal for the pop-up output data from the set-top box; and
transmitting, by the media providing server, extended pop-up output data to the set-top box in response to the extension signal.

7. The method of claim 1, further comprising:
receiving, at the media providing server, a selection request signal for an order function included in the pop-up output data from the set-top box; and
transmitting, by the media providing server, order output data corresponding to the order function to the set-top box in response to the selection request signal for the order function.

8. A computer program stored on a computer-readable storage medium for executing the method of claim 1 using a computer.

9. A media providing server comprising:
a communication unit; and
a processor configured to communicate with a set-top box,
wherein the processor is further configured to:
receive an access signal from the set-top box, transmit video identification information of broadcast video data to the set-top box in response to the access signal;
determine whether a pop-up posting condition is satisfied with respect to the set-top box;
generate pop-up output data matching the pop-up posting condition upon determination that that the pop-up posting condition is satisfied; and
transmit the pop-up output data to the set-top box.

10. The media providing server of claim 9, wherein the pop-up posting condition comprises whether a broadcast video displayed by the set-top box is a predetermined video.

11. The media providing server of claim 9, wherein the pop-up posting condition further comprises whether a current time value of the set-top box is in a predetermined period.

12. The media providing server of claim 9, wherein the pop-up posting condition further comprises a determination of whether:
at least one of a broadcast video output from the set-top box;
a time value;
platform information of the set-top box;
a voice recognition function of the set-top box; or
a characteristic of a product sold in the broadcast video;
matches predetermined pop-up posting conditions.

13. The media providing server of claim 9, wherein the processor is further configured to:
receive a selection request signal for a banner included in the pop-up output data from the set-top box;
request video identification information of a store video corresponding to the banner from a data server in response to the selection request signal;
receive the video identification information from the data server; and
transmit the video identification information to the set-top box.

14. The media providing server of claim 9, wherein the processor is further configured to receive an extension signal for the pop-up output data from the set-top box, and transmit extended pop-up output data to the set-top box in response to the extension signal.

15. The media providing server of claim 9, wherein the processor is further configured to:
receive a selection request signal for an order function included in the pop-up output data from the set-top box, and
transmit order output data corresponding to the order function to the set-top box in response to the selection request signal for the order function.

16. A system for providing media comprising:
an input unit that receives a user input;
an output unit that displays a user interface for the user input;
a communication unit configured to transmit and receive data over a network;
a processor unit; and
a storage medium coupled to the processor unit and comprising:
a broadcast video processing unit, upon execution by the processor unit, configured to receive information about a broadcast video corresponding to a broadcast schedule or a user input;
a pop-up screen processing unit, upon execution by the processor unit, configured to request and receive pop-up data related to a connected set-top box and generate pop-up output data based on received pop-up data;
a user input management unit, upon execution by the processor unit, configured to receive a signal corresponding to a user input obtained from a set-top box; and
a broadcast output management unit, upon execution by the processor unit, configured to generate output data by combining video identification information with the pop-up output data of the broadcast video;
wherein upon execution by the processor unit, the pop-up screen processing unit is further configured to:
determine whether pop-up posting conditions are satisfied; and
upon determination that the pop-up posting conditions are satisfied, control a pop-up screen corresponding to the pop-up posting conditions to be output.

17. The system of claim 16, wherein the pop-up screen processing unit is further configured to:
upon determination that pop-up posting conditions are satisfied, generate the pop-up output data using a voice recognition function.

18. The system of claim 16, wherein the pop-up screen processing unit is further configured to:
upon determination that pop-up posting conditions are satisfied:
generating the pop-up output data including a first type execution user interface corresponding to a first product type included in the broadcast video; and
generating the pop-up output data including a second type execution user interface corresponding to a second product type included in the broadcast video.

19. The system of claim 16, wherein the pop-up screen processing unit is further configured to:
receive a first selection request signal for a banner included in the pop-up output data from the connected set-top box; and
transmit video identification information of a store video corresponding to the banner to the connected set-top box in response to the first selection request signal.

20. The system of claim 19, wherein the pop-up screen processing unit is further configured to:
receive a second selection request signal for an order function included in the pop-up data from the connected set-top box; and
transmit order output data corresponding to the order function to the connected set-top box in response to the second selection request signal for the order function.
